(19) United States
(12) Patent Application Publication
(10) Pub. No.: US 2004/0095469 A1
(43) Pub. Date: May 20, 2004

(54) Digital camera capable of generating print data

(76) Inventor: Fu-Chang Lin, Taipei City (TW)

Correspondence Address: NAIPO (NORTH AMERICA INTERNATIONAL PATENT OFFICE), P.O. BOX 506, MERRIFIELD, VA, 22116, US

(21) Appl. No.: 10/065,783

(22) Filed: Nov. 18, 2002

(51) Int. Cl. H04N 5/225

(52) U.S. Cl. 348/207.2

(57) ABSTRACT

A digital camera for generating and sending device-dependent print data to a printer is disclosed. The digital camera has a housing with an opening at a front end for receiving incident light, a sensor installed at a rear end of the housing for detecting the incident light so as to generate raw data, a printer manager having a converter for converting the raw data into the device-dependent print data, and an I/O driver for outputting the device-dependent print data to the printer so that the printer is capable of printing the device-dependent print data automatically.

### BACKGROUND OF INVENTION

1. Field of the Invention

The present invention relates to digital camera, and more particularly, to a digital camera capable sending print data to a printer without utilizing another additional device.

2. Description of the Prior Art

Enormous advances in digital electronics over the past years have resulted in more and more consumers switching over from traditional analog devices to their digital equivalents. A particularly relevant example of this is the digital camera, which is rapidly replacing film-based cameras. Digital cameras enable a user to preview a frame, and to select those frames that are to be kept, while discarding unwanted frames. This offers a great advantage over the previous incarnation of film-based cameras, in which the frames were inerasably caught within the emulsion of the film, and which could not be viewed until the film was developed often many days or weeks after the frame itself was taken.

Based on the prior art, when a user wants to print the digital images captured by a digital camera, the digital images should be downloaded from the digital camera to a computer so that the computer can generate corresponding print data to a printer to print. Generally, a personal computer performs printer control operations according to an operating system (OS) installed therein. Please refer to FIG. 1, which is a functional block diagram of a conventional personal computer system 20 connected a digital camera 10 performing a printer control operation on a printer 40 according to the prior art. The digital camera 10 is used to capture images so as to generate digital image data 12. The digital image data is encoded and stored in a specific format, such as such as a RAW format, a JPEG (joint photographic experts group) format, GIF (graphics interchange format), BMP (bitmap) format, or TIFF (tag image file format). The computer system 20 is electrically connected to the printer 40 and is capable of controlling the printer 40 to print documents. When the user wants to print the encoded data 12 generated by the digital camera 10 via the printer 40, he or she must connect the digital camera 10 to the computer system 20, and then download the encoded data 12 from the digital camera 10 to the computer system 20 so as to convert the encoded data 12 into print data and to transmit the print data to the printer 40.

The computer system 20 comprises an operating system (OS) 22, which is the Windows 95 operating system published by Microsoft Corp., and an application 24. The OS 22 comprises an upper layer 25 for controlling a graphical device interface (GDI) 26 and a lower layer 28 for controlling input/output activities. The GDI 26 is a program module provided by the operating system “Windows 95 (trade mark)” and is a “Windows (trade mark)” standard for representing graphical objects. The application 24 is a graphical processing program, such as Adobe Photoshop published by Adobe Systems Incorporated. The application 24 can read the encoded data 12 generated by, the digital camera 10, and then display the image by decoding the encoded data 12. Generally, when a user wants to print the image of the encoded data 12, he or she must control the OS 22 to open the application 24 so as to command the application 24 to read the encoded data 12, and then select a print menu command of the application 24 to control the printer 40 to print the image of the encoded data 12. When the print command of the application 24 is generated, the GDI 26 and a printer driver 30 of the printer 40 are used to decode the encoded data 12. When the encoded data 12 is decoded, the encoded data 12 is converted into raw data, and then the raw data are converted into print data. The print data is transmitted to the printer 40 via an input/output (I/O) driver 38 of the lower layer 28 so that the printer 40 can print the print data received from the computer system 20.

Before the encoded data 12 are decoded, the user can configure the operations of the printer 40 via a user interface 27. For example, the user can select the sheet size and printing direction via the user interface 27. The GDI 26 and the printer driver 30, thus, will decode the encoded data 12 according to configuration information of the user interface 27. Furthermore, if the computer system 20 connects to a plurality of printers, the user can select one of the printers to print the image of the encoded data 12 by using the user interface 27. Additionally, the printer driver 30 has a halftoning module 32 for converting the raw data into gray-level image data and a CMM&Screening module 34 for converting the raw data into cyan-magenta-yellow-black (CMYK) image data, and no matter the raw data is converted into the gray-level image data or into the CMYK image data, the raw data finally is converted into the print data by the halftoning module 32 or by the CMM&Screening module 34. The lower layer 28 further comprises a spooler 36 that is a software program executed on the computer system 20 to temporarily store the print data in the memory or the hard disk provided to the computer system 20 and to transfer the print data to the printer 40 according to the printing state of the printer 40.

Because the digital camera 10 is not capable of generating the print data, the user must connect the digital camera 10 to the computer system 20 when he or she wants the print the encoded data 12 captured by the digital camera 10 via the printer 40. It is a disadvantage that the user should have to use the computer system to generate,, the print data. If the user has no device for generating the print data (such as the computer system), it becomes inconvenient to print the encoded data 12 via the printer 40.

### SUMMARY OF INVENTION

It is therefore a primary objective of the present invention to provide a digital camera for generating device-dependent print data to a printer without any additional device so that the print data can be directly sent to the printer.

According to the claimed invention, a digital camera has a housing having an opening at a front end for receiving incident light, a sensor installed at a rear end of the housing for detecting the incident light so as to generate raw data, a printer manager having a converter for converting the raw data into the device-dependent print data, and an I/O driver for outputting the device-dependent print data to the printer so that the printer is capable of printing the device-dependent print data.

It is an advantage of the present invention that the print data is generated without utilizing any additional computer system so that the operation for printing the images captured by the digital camera can be simplified.

These and other objectives of the present invention will no doubt become obvious to those of ordinary skill in the art after reading the following detailed description of the preferred embodiment, which is illustrated in the various figures and drawings.

### BRIEF DESCRIPTION OF DRAWINGS

FIG. 1 is a functional block diagram of a conventional personal computer system connected to a digital camera performing a printer control operation on a printer according to the prior art.

FIG. 2 is perspective view of a digital camera according to the present invention.

FIG. 3 is a section view along line 3-3 of the digital camera in FIG. 2.

FIG. 4 is a functional block diagram of the digital camera in FIG. 2 connected to the printer in FIG. 1.

### DETAILED DESCRIPTION

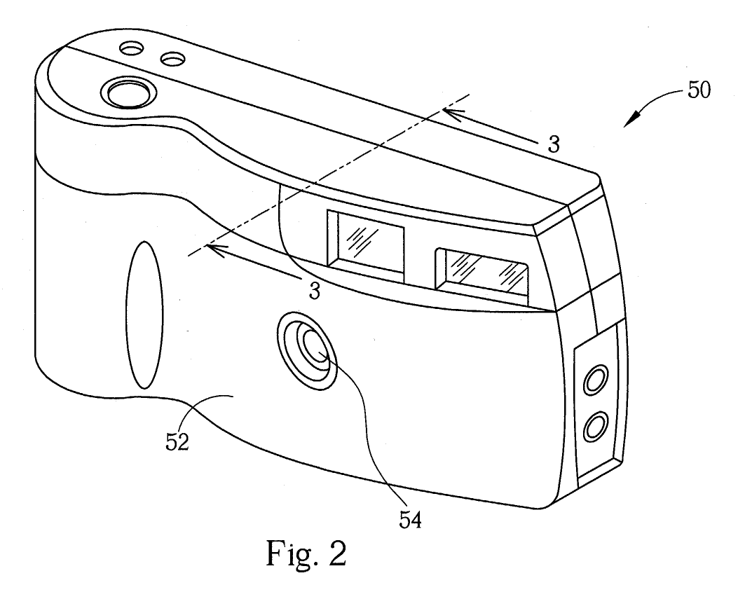

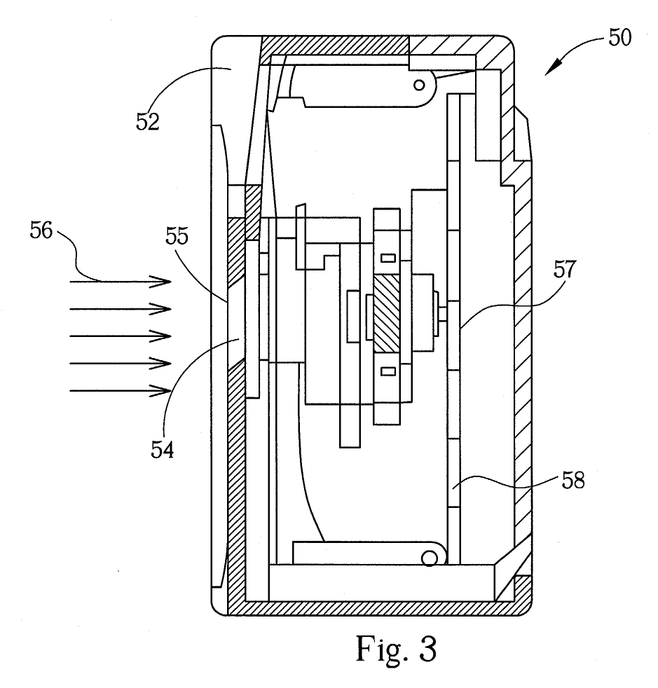

Please refer to FIG. 2 and FIG. 3. FIG. 2 is a perspective view of a digital camera 50 according to the present invention. FIG. 3 is a section view along line 3-3 of the digital camera 50 in FIG. 2. The digital camera 50 directly connects to the printer 40, and comprises a housing 52 for containing a plurality of components of the digital camera 50 and a sensor 58 for detecting incident light 56. The housing 52 has an opening 54 at a front end 55 for receiving the incident light 56. The sensor 58 is installed at a rear end 57 of the housing 52 and is used to detect the incident light 56 to generate raw data 62.

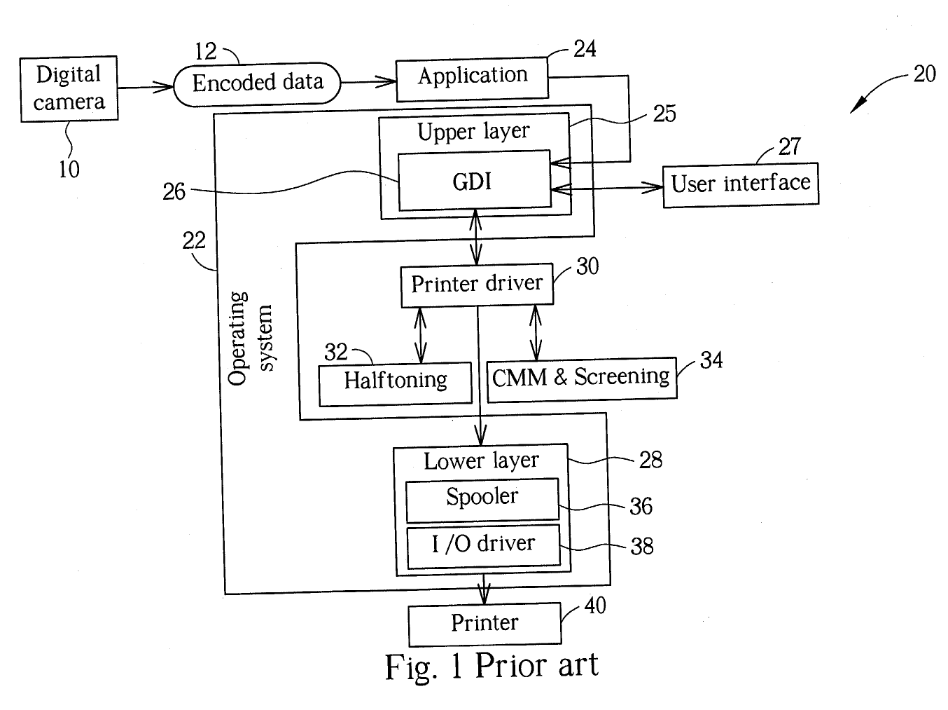

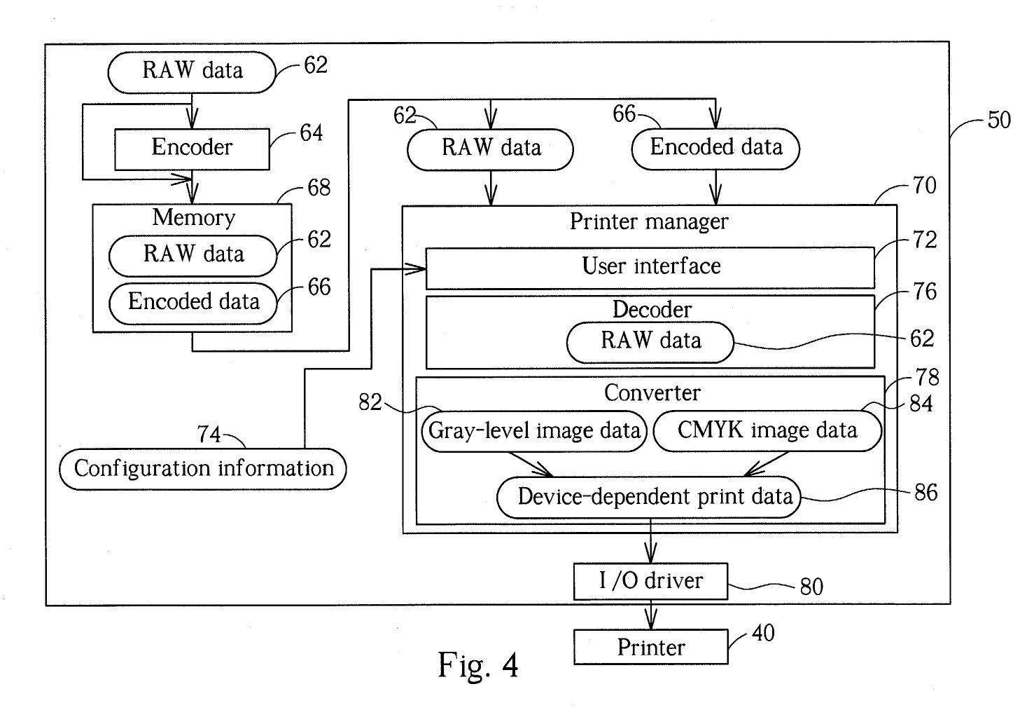

Please refer to FIG. 4, which is a functional block diagram of the digital camera 50 in FIG. 2 connected to the printer 40 in FIG. 1. The digital camera 50 further comprises an encoder 64 for encoding the raw data 62 into encoded data 66, a memory 68 for storing the raw data 62 and the encoded data 66, a printer manager 70 for generating device-dependent print data 86, and an I/O driver 80 for outputting the device-dependent print data 86 to the printer 40. When the digital camera 50 generates the raw data 62, the raw data 62 can either be directly stored in the memory 68 or be encoded by the encoder 64. The encoded data 66 is stored in a specific image format, such as a JPEG (joint photographic experts group) format, GIF (graphics interchange format), BMP (bitmap) format, or TIFF (tag image file format). A user can directly connect the digital camera 50 with the printer 40 to print the image of the raw data 62 or of the encoded data 66 by using a user interface 72 of the printer manager 70. The user interface 72 may have a plurality of buttons and an on-screen display (OSD) function, which are used to control the operations of the digital camera 50.

Before the print data 86 is transmitted to the printer 40, the printer manager 70 receives the raw data 62 or the encoded data 66 from the memory 68. The printer manager 70 is capable of detecting what image type the received data is, i.e. the raw data 62 or the encoded data 66. If the received data of the printer manager 70 is the raw data 62, a converter 78-of the printer manager 70 directly converts the raw data 62 into the print data 86. Otherwise, if the received data of the printer manager 70 is the encoded data 66, a decoder 76 of the printer manager 70 decodes the encoded data 66 into the raw data 62 and then the converter 78 converts the raw data 62 into the print data 86. Once the print data 86 is generated by the printer manager 70, the I/O driver 80 outputs the print data 86 to the printer 40.

Note that the printer manager 70 generates the print data 86 without utilizing any external device like the computer system 20 in FIG. 1, so no additional device is needed while the digital camera 50 generates the print data 86. When the user wants to control the printer 40 to print the image of raw data 62 or of the encoded data 66, the only thing he or she needs to do is to connect the digital camera 50 to the printer 40 so as to control the digital camera 50 to generate the print data 86 to the printer 40. Once the print data 86 is generated and transmitted to the printer 40, the printer 40 can print the print data 86 automatically.

To fit various print requirements, the user interface 72 is used to configure the printer manager 70. When the converter 78 starts to convert the raw data 62, a settings screen of the user interface 72 appears on a display device of the digital camera 50 so that the user can configure follow-up operations of the printer manager 70; and the converter 76 will convert the raw data 62 into the device-dependent print data 86 according to configuration information 74 of the user interface 72. For example, the user can control the printer 40 to operate in a monochrome print mode or in a color print mode via the user interface 72. If the printer 40 is controlled to operate in the monochrome print mode, the converter 78 converts the raw data 62 into gray-level image data 82 and then converts the gray-level image data 82 into the device-dependent print data 86. If the printer 40 is controlled to operate in the color print mode, the converter 78 converts the raw data 62 into cyan-magenta-yellow-black (CMYK) image data 84 and then converts the CMYK image data 84 into the device-dependent print data 86. Note that the print data 86 is device-dependent,-the print data 86 must be generated according to the machine type of the printer 40 so as to make the print data 86 compatible with the printer 40. Therefore, when the digital camera 50 connects to the printer 40, the digital camera 50 detects the machine type of the printer 40. Moreover, the user can set the machine type of the printer 40 via the user interface 72, and the digital camera 50 generates corresponding print data 86 according to the machine type of the printer 40 set by the user interface 72. The digital camera 50, thus, can output proper print data to various printers.

In contrast to the prior art, the present invention provides a digital camera for outputting device-dependent print data to the printer without utilizing any additional device except the printer and the digital camera. The procedure of printing images captured by the digital camera for users, thus, can be simplified.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A digital camera for generating device-dependent print data to a printer, the digital camera comprising:
a housing having an opening at a front end for receiving incident light;
a sensor installed at a rear end of the housing for detecting the incident light so as to generate raw data;
a printer manager having a converter for converting the raw data into the device-dependent print data; and
an I/O driver for outputting the device-dependent print data to the printer so that the printer is capable of printing the device-dependent print data.

2. The digital camera of claim 1 further comprising an encoder for encoding the raw data into encoded data, and a memory device for storing the encoded data.

3. The digital camera of claim 2 wherein the encoded data is stored in a joint photographic experts group (JPEG) format.

4. The digital camera of claim 2 wherein the encoded data is stored in a graphics interchange format (GIF).

5. The digital camera of claim 2 wherein the encoded data is stored in a bitmap (BMP) format.

6. The digital camera of claim 2 wherein the encoded data is stored in a tag image file format(TIFF).

7. The digital camera of claim 2 wherein the printer manager decodes the encoded data to re-generate the raw data.

8. The digital camera of claim 1 wherein the converter converts the raw data into gray-level image data and converts the gray-level image data into the print data.

9. The digital camera of claim 1 wherein the converter converts the raw data into cyan-magenta-yellow-black (CMYK) image data and converts the CMYK image data into the print data.

10. The digital camera of claim 1 further comprising a user interface for controlling operations of the digital camera.
